(19) United States
(12) Patent Application Publication
(10) Pub. No.: US 2026/0243232 A1
(43) Pub. Date: Aug. 20, 2026

(54) PLAIN BEARING ARRANGEMENT, NACELLE EQUIPPED WITH THE PLAIN BEARING ARRANGEMENT FOR A WIND POWER PLANT, AND WIND POWER PLANT

(71) Applicant: Miba Gleitlager Austria GmbH, Laakirchen (AT)

(72) Inventors: Patrick LAUBICHLER, Gmunden (AT); Johannes HOELZL, Berg im Attergau (AT); Albert WALDL, Laakirchen (AT); Christopher ZEH, Obernfeld (DE)

(73) Assignee: Miba Gleitlager Austria GmbH, Laakirchen (AT)

(21) Appl. No.: 18/992,650

(22) PCT Filed: Jul. 12, 2023
(86) PCT No.: PCT/AT2023/060235

§ 371 Date: Jan. 9, 2025

(30) Foreign Application Priority Data
Jul. 12, 2022 (AT) A 50515/2022

(51) Int. Cl. F03D 80/70; F16C 17/02; F16C 33/10

(52) U.S. Cl. CPC F03D 80/70; F16C 17/02; F16C 33/104; F05B 2240/50; F16C 2240/70; F16C 2360/31

(57) ABSTRACT

A plain bearing includes an inner ring element, an outer ring element, and at least one plain bearing element arranged between the inner ring element and the outer ring element, wherein using the plain bearing element the outer ring element and the inner ring element are mounted such that they can be rotated relative to one another about an axis of rotation, wherein the plain bearing element includes plain bearing pads, wherein the individual plain bearing pads each have a curved bearing surface. The curved bearing surface has a first radius in a longitudinal section along the axis of rotation and has a second radius in a cross section normal to the axis of rotation. In particular, the second radius is greater than the first radius.

The invention relates to a plain bearing arrangement and to a nacelle equipped with the plain bearing arrangement for a wind turbine, and to a wind turbine.

DE 650737 C discloses a plain bearing arrangement with an inner ring element and an outer ring element, wherein a plurality of plain bearing pads are arranged on the inner ring element. The plain bearing pads have a sliding surface in the form of a spherical cap, which interacts with a corresponding sliding surface on the outer ring element. Such spherical bearings are used to be able to absorb a radial force as well as an axial force between an inner ring element and an outer ring element.

Spherical bearings according to DE 650737 C have to have a certain width for a predetermined axial load capacity, such that a certain projected axial surface is achieved. Since the radial load capacity of spherical bearings is also dependent on the width, an unnecessarily high radial load capacity is often achieved. This leads to spherical bearings often being over-dimensioned in respect of their radial load capacity, thus having a high weight.

The object of the present invention was to provide an improved plain bearing arrangement. In particular, the object of the present invention was to provide a plain bearing arrangement that has as small a plain bearing pad width as possible with a predetermined diameter, wherein at the same time the radial load capacity and the axial load capacity ought to be adapted to the predetermined load profile.

This object is solved by an apparatus according to the claims.

According to the invention, a plain bearing arrangement is provided. The plain bearing arrangement comprises:
an inner ring element;
an outer ring element;
at least one plain bearing element arranged between the inner ring element and the outer ring element, wherein by means of the plain bearing element the outer ring element and the inner ring element are mounted such that they can be rotated relative to one another about an axis of rotation, wherein the plain bearing element comprises a plurality of plain bearing pads,
wherein the individual plain bearing pads each have a curved bearing surface.

The curved bearing surface has a first radius in a longitudinal section along the axis of rotation and has a second radius in a cross section normal to the axis of rotation. In particular, it can be provided that the second radius is greater than the first radius.

The plain bearing arrangement according to the invention has the surprising advantage that, due to the different radii, the axial load capacity and the radial load capacity of the plain bearing arrangement can complement one another at a predetermined diameter of the inner ring element. The weight of the individual plain bearing pads can thus be reduced.

Furthermore, the efficiency of the plain bearing arrangement can be improved by optimizing the axial load capacity and the radial load capacity of the plain bearing arrangement.

A counterface can be provided that corresponds with the bearing surface. The bearing surface and the counterface can together form a plain bearing pair.

A longitudinal section along the axis of rotation has a cutting plane line that extends in the axial direction of the plain bearing arrangement. The axis of rotation is hereby in the section plane of the cutting plane line. In other words, the section plane of the longitudinal section is exactly central and thus arranged in the axis of rotation of the plain bearing arrangement.

The axial position of the cross section normal to the axis of rotation is selected at the position of the axial vertex of the bearing surface.

In particular, it can be provided that the first radius extends in the axial direction and that the second radius extends in the circumferential direction. Furthermore, it can be provided that the first radius has a constant value over the entire axial extension of the bearing surface. The first radius can have a center point that is at a radial distance from the axis of rotation.

Furthermore, it can be expedient for the bearing surface of the plain bearing pads to be configured as a torus segment of a torus with a circular cross section. In particular a bearing surface in the form of a torus segment can be manufactured with sufficiently high precision. Moreover, this bearing surface shape can provide good functionality.

A torus segment can be formed by arranging a circular cross section with the first radius at a distance to the axis of rotation and rotating it about the axis of rotation. The distance to the axis of rotation can thereby be selected such that an axial vertex, i.e. the radially outermost point, is arranged at a distance of the second radius from the axis of rotation.

Furthermore, it can be provided that the first radius is between 5% and 99%, in particular between 10% and 50%, preferably between 15% and 30% of the second radius. This measure provides the advantage that a particularly good distribution between radial load capacity and axial load capacity can be achieved.

Moreover, it can be provided that the second radius is measured at an axial vertex.

An embodiment according to which it can be provided that the plain bearing pads, starting from the axial vertex, have a first axial extension in a first axial direction and a second axial extension in a second axial direction, wherein the first axial extension is greater than the second axial extension, is also advantageous. This measure provides the advantage that, with as compact a construction as possible, the plain bearing pad has a good capacity to absorb axial forces acting in a primary load direction. In accordance with requirements, lower axial forces can be absorbed in the axial secondary load direction. Due to the different values of the first axial extension and the second axial extension, the plain bearing arrangement can be specifically adjusted to the requirements.

According to a further embodiment, it is possible that the second axial extension is between 5% and 99%, in particular between 20% and 95%, preferably between 50% and 80% of the first axial extension. This measure provides the advantage that, with as compact a construction as possible, the plain bearing pad has a good capacity to absorb axial forces acting in a main load direction. In accordance with requirements, lower axial forces can be absorbed in the axial secondary load direction, whereby overall the structural extension of the plain bearing arrangement can be kept as low as possible.

In an alternative embodiment variation, it can be provided that the plain bearing pads, starting from the axial vertex, have a first axial extension in a first axial direction and a second axial extension in a second axial direction, wherein the first axial extension is equal to the second axial extension. A plain bearing pad configured in such a way can have as simple a structure as possible. Furthermore, a plain bearing pad configured in such a way can bear equal loads in both axial directions.

According to an advantageous embodiment, it can be provided that the plain bearing pads have a plain bearing pad width, wherein the plain bearing pad width is between 20% and 170%, in particular between 60% and 140%, preferably between 90% and 120% of the first radius. In particular plain bearing pads with such a ratio of plain bearing pad to first radius have surprisingly low wear.

In a further embodiment variation, it can be provided that the second radius has a different value to the first radius, wherein the first radius has a constant value over the entire axial extension of the bearing surface. In other words, the first radius can have a constant radius over the entire axial extension of the bearing surface, whereby the resulting surface is not a spherical cap. The resulting bearing surface deviates from the shape of a spherical cap if the second radius is greater than the first radius or the second radius is smaller than the first radius. For the sake of simplicity, the skilled person would select the first radius and the second radius to be of the same size in order to be able to manufacture the bearing surface as simply as possible. The bearing surface would thereby have a spherical cap shape. This measure according to the invention allows for the simple manufacture of the bearing surface due to the constant value over the entire axial extension, and at the same time the ratio of radial load capacity to axial load capacity can be configured due to the different value of the second radius to the first radius. The plain bearing element can thus have as small a width as possible overall, selected such that the radial load capacity can be achieved with a predetermined second radius. The axial load capacity can be configured by adjusting the first radius.

It can thus be provided in a first embodiment that the second radius is greater than the first radius. A high axial load capacity can thereby be achieved with given radial load capacity.

In a further embodiment example it can be provided that the second radius is smaller than the first radius. Such an embodiment can be advantageous if only low requirements are made of axial load capacity with given radial load capacity.

According to the invention, a nacelle for a wind turbine is provided, the nacelle comprising:
a nacelle housing;
a rotor hub;
a rotor bearing arrangement for mounting the rotor hub on the nacelle housing. The rotor bearing arrangement comprises a plain bearing arrangement according to one of the above embodiments.

In particular in the case of nacelles according to the invention, the plain bearing arrangement according to the invention leads to simple maintainability of the plain bearing arrangement.

Furthermore, it can be provided that the plain bearing pads of the plain bearing arrangement, starting from the axial vertex, have a first axial extension in a first axial direction and a second axial extension in a second axial direction, wherein the first axial extension is greater than the second axial extension, wherein the plain bearing pads are received in the nacelle housing in such a way that the first axial extension is formed on a side of the axial vertex that is facing away from the rotor hub. This measure provides the advantage that the increased axial force on the plain bearing pads can be absorbed particularly well. The increased axial force on the plain bearing pads arises from the wind force on the rotor hub.

According to a particular embodiment, it is possible that a first rotor shaft bearing and a second rotor shaft bearing are provided, wherein the first rotor shaft bearing is arranged nearer to the rotor hub than the second rotor shaft bearing, wherein the second rotor shaft bearing is configured as a plain bearing arrangement according to the above embodiments. Such a construction has a surprisingly simple design, wherein the forces arising in the rotor shaft can be absorbed well by the described embodiment.

According to an advantageous embodiment, it can be provided that the plain bearing pads are mounted on a rotor shaft.

Furthermore, it can be expedient if the individual plain bearing pads each have a mounting profile opposite the bearing surface.

In particular, it can be provided that the inner ring element has at least one receiving means on its radial outer side that serves for the positive connection of the plain bearing pads with the inner ring element. This measure means that a simple exchangeability of the plain bearing pads can be achieved and at the same time a secure positioning of the plain bearing pads can be achieved in the operable state of the plain bearing arrangement.

According to a particular embodiment, it is possible that an axial stop for the plain bearing pad is configured on the inner ring element in the region of the receiving means. This provides the advantage that the plain bearing pad can be exactly positioned in the axial direction.

According to an advantageous further embodiment, it can be provided that a fastening element is provided by means of which the plain bearing pad is pressed against the axial stop in the axial direction. This provides the advantage that the plain bearing pad can be fixed or correctly positioned in the axial direction in order to ensure the functionality of the plain bearing arrangement.

Furthermore, it can be provided that at least one anti-rotation element is provided which acts between the axial stop ring and at least one of the plain bearing pads. This measure allows for at least one of the plain bearing pads to be secured against rotation relative to a shaft.

Furthermore, it can be provided that the axial stop is provided on a stop ring that is mounted on a shaft. In particular, it can be provided that the axial stop ring is shrunk onto the shaft.

In an alternative embodiment variation, it can be provided that the axial stop is formed directly on the shaft. Furthermore, it can be provided that a positioning lug is provided on the plain bearing pad that corresponds with the axial stop.

In an alternative embodiment variation, it can be provided that the plain bearing pads are mounted on the nacelle housing. This can be performed directly or by interpositioning a bearing mount.

In such an embodiment, the bearing surface can be formed on an inner side of the plain bearing pads.

A counterface for the bearing surface can be formed on the inner ring element. In particular, it can be provided that the counterface is formed directly on the shaft, wherein the shaft forms the inner ring element. In an alternative embodiment variation, it can also be provided that the counterface is arranged on a structurally independently formed inner ring element, wherein the inner ring element is coupled with the shaft. In particular, it can be provided that the inner ring element is shrunk onto the shaft.

In particular, it can be provided that the outer ring element has at least one receiving means on its radial inner side that serves for the positive connection of the plain bearing pads with the outer ring element. This measure means that a simple exchangeability of the plain bearing pads can be achieved and at the same time a secure positioning of the plain bearing pads can be achieved in the operable state of the plain bearing arrangement.

According to a particular embodiment, it is possible that an axial stop for the plain bearing pad is configured on the outer ring element in the region of the receiving means. This provides the advantage that the plain bearing pad can be exactly positioned in the axial direction.

According to an advantageous further embodiment, it can be provided that a fastening element is provided by means of which the plain bearing pad is pressed against the axial stop on the outer ring element in the axial direction. This provides the advantage that the plain bearing pad can be fixed or correctly positioned in the axial direction in order to ensure the functionality of the plain bearing arrangement.

Furthermore, the invention relates to a wind turbine with a nacelle, the nacelle comprising:
a nacelle housing;
a rotor hub with rotor blades arranged thereon;
a rotor bearing arrangement for mounting the rotor hub on the nacelle housing. The rotor bearing arrangement comprises a plain bearing arrangement according to one of the above embodiments.

According to a particular embodiment, it is possible that the rotor bearing arrangement comprises a bearing mount in which the outer ring element is received.

In an alternative embodiment variation, it can be provided that the bearing mount is directly formed as an outer ring element.

The bearing mount can be mounted on the nacelle housing.

In an alternative embodiment variation it is also conceivable that the bearing mount is provided directly in the nacelle housing. It can thus also be provided that the outer ring element is provided directly in the nacelle housing.

According to a further embodiment, it is possible that a removal opening is provided in the outer ring element which, starting from a first front side of the outer ring element, interrupts the counterface of the outer ring element. This measure provides the advantage that the individual plain bearing pads can be changed simply without the entire plain bearing arrangement having to be dismantled into its separate parts. In particular, it is conceivable that this measures allows for the individual plain bearing pads to be changed in the assembled state of the plain bearing arrangement without having to completely dismantle the latter. Furthermore, it can be provided that the removal opening extends from a first front side of the outer ring element at least to the vertex of the plain bearing element.

Furthermore, it is conceivable that in the operating state of the plain bearing arrangement a porous material, such as a sponge, is arranged in the removal opening, which serves to temporarily absorb lubricating oil. This measures means that the sliding surface of the individual plain bearing pads are evenly covered with a lubricating oil film.

The individual plain bearing pads can be simply removed from their operating position through the removal opening.

Furthermore, it can be provided that the removal opening has a radially flared configuration towards the first front side. This provides the advantage that the outer ring element can have as high a stability as possible and at the same time the plain bearing pad can be removed through the removal opening as simply as possible.

Moreover, it can be provided that a plain bearing pad receiving ring is provided which serves to fasten the plain bearing pads, wherein the plain bearing pad receiving ring is received on the inner ring element. This measure provides the advantage that the plain bearing pads can be rigidly coupled with the inner ring element.

Furthermore, it can be provided that the plain bearing pad receiving ring is shrunk onto the inner ring element. In particular for rotor shafts, this provides an extremely durable and practicable connection. During shrinking, the plain bearing pad receiving ring is heated and/or the inner ring element cooled to facilitate axial press-fitting. After temperature compensation and thus compensation of the thermal expansions, the plain bearing pad receiving ring can be securely positioned on the inner ring.

In an alternative embodiment variation or in addition, it can be provided that the plain bearing pad receiving ring is coupled with the inner ring element by means of a bonded connection, such as a welding connection.

In yet another alternative embodiment variation, it can be provided that the plain bearing pad receiving ring is coupled with the inner ring element by means of a positive connection, such as a screw connection.

Furthermore, it can be provided that a plurality of threaded holes are provided in the plain bearing pad receiving ring, which are arranged in the axial direction of the plain bearing pad receiving ring and serve to receive fixing screws, wherein through-holes are provided in the plain bearing pads through which the fixing screws are inserted in order to clamp the plain bearing pads on the plain bearing pad receiving ring by means of the fixing screws. Such a connection between the plain bearing pads and the plain bearing pad receiving ring can be created simply.

In a further embodiment, it can be provided that the plain bearing pads have a ledge on their inner side, where said ledge rests on a front side of the plain bearing pad receiving ring, wherein the through-holes are arranged in the region of the ledge. This measure ensures that a sufficiently resilient connection is achieved between the plain bearing pads and the inner ring.

In a first embodiment variation, it can be provided that the plain bearing arrangement is provided as a hydrodynamic bearing arrangement.

In a further alternative embodiment variation, it can be provided that the plain bearing arrangement is provided as a hydrostatic bearing arrangement.

In yet another alternative embodiment variation, it can be provided that the plain bearing arrangement is provided as a self-lubricating bearing arrangement.

For a better understanding of the invention, it is explained in more detail with reference to the following figures.

These show in significantly simplified, schematic representation:

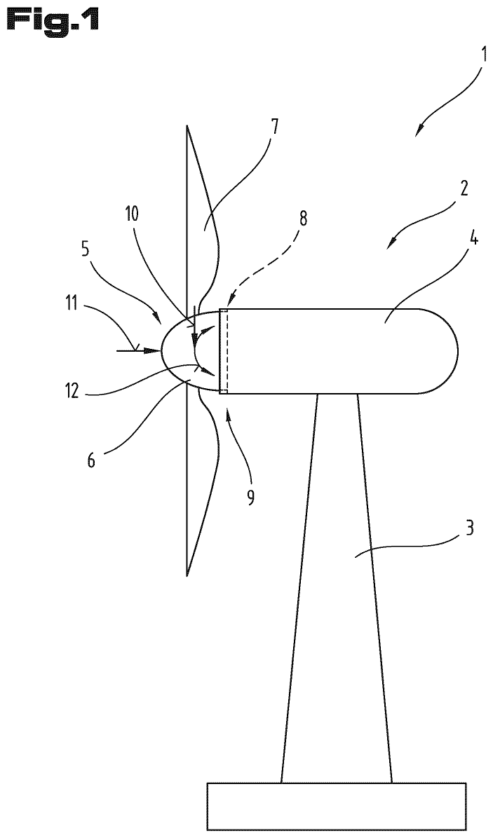

FIG. 1 a schematic representation of a wind turbine;

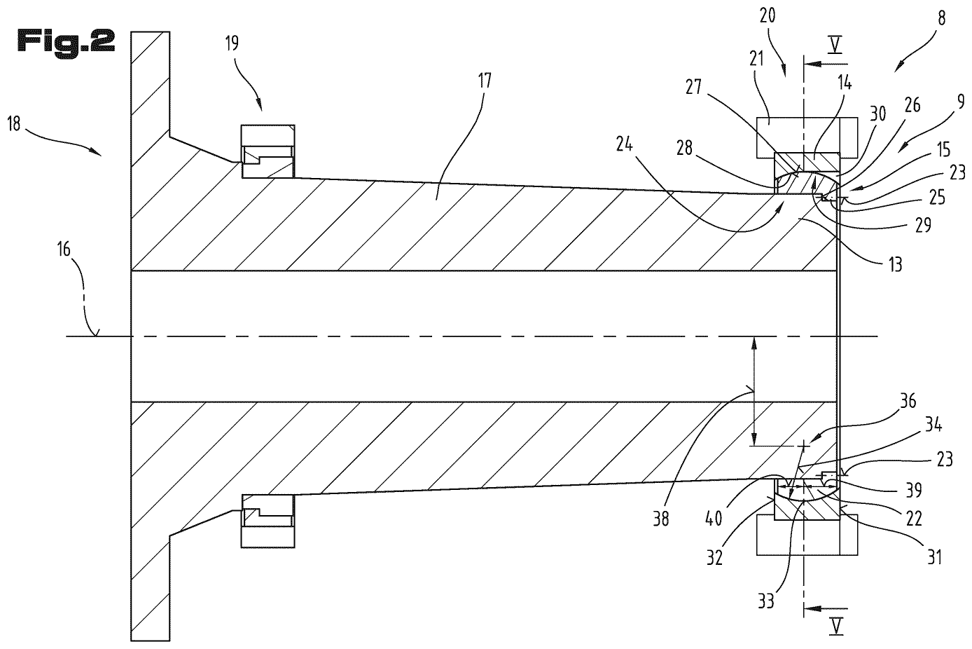

FIG. 2 a longitudinal section representation of a first example embodiment of a plain bearing arrangement;

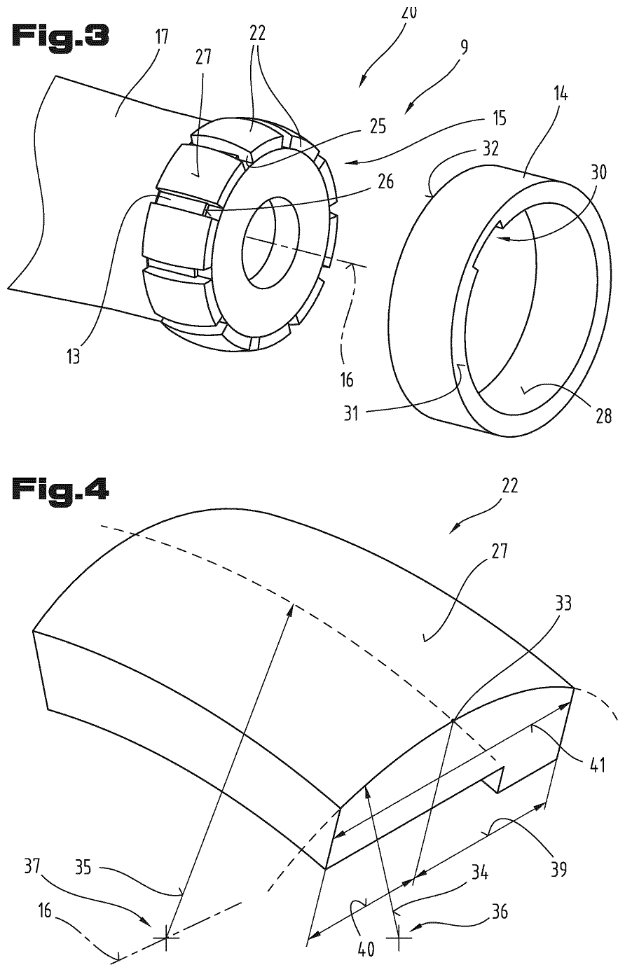

FIG. 3 a perspective representation of the plain bearing arrangement;

FIG. 4 a perspective view of a plain bearing pad;

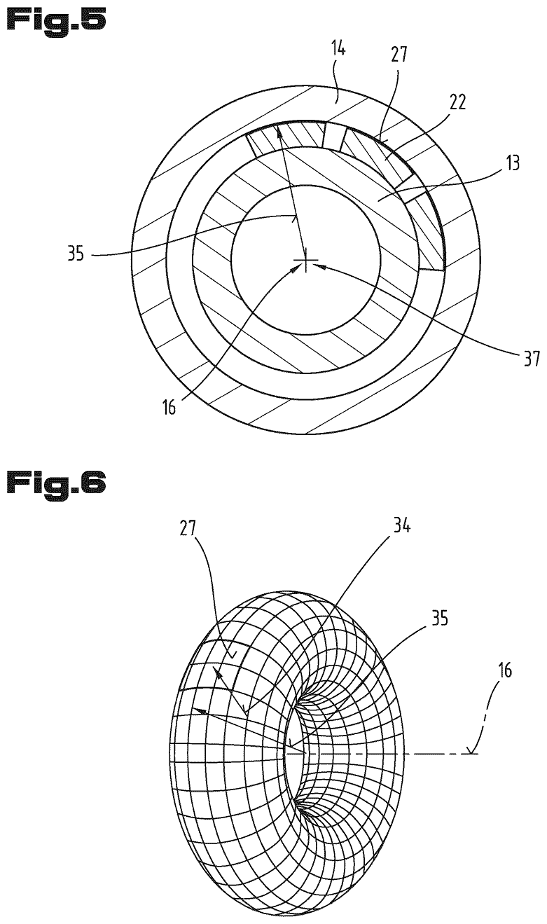

FIG. 5 a cross-section representation according to the section line V-V from FIG. 2;

FIG. 6 a perspective representation of a torus with plotted sliding surface;

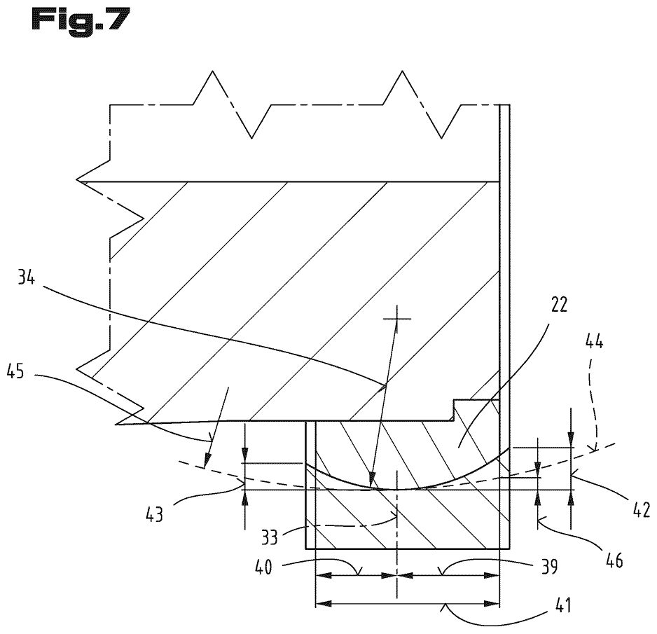

FIG. 7 a close-up view of the longitudinal section representation from FIG. 2;

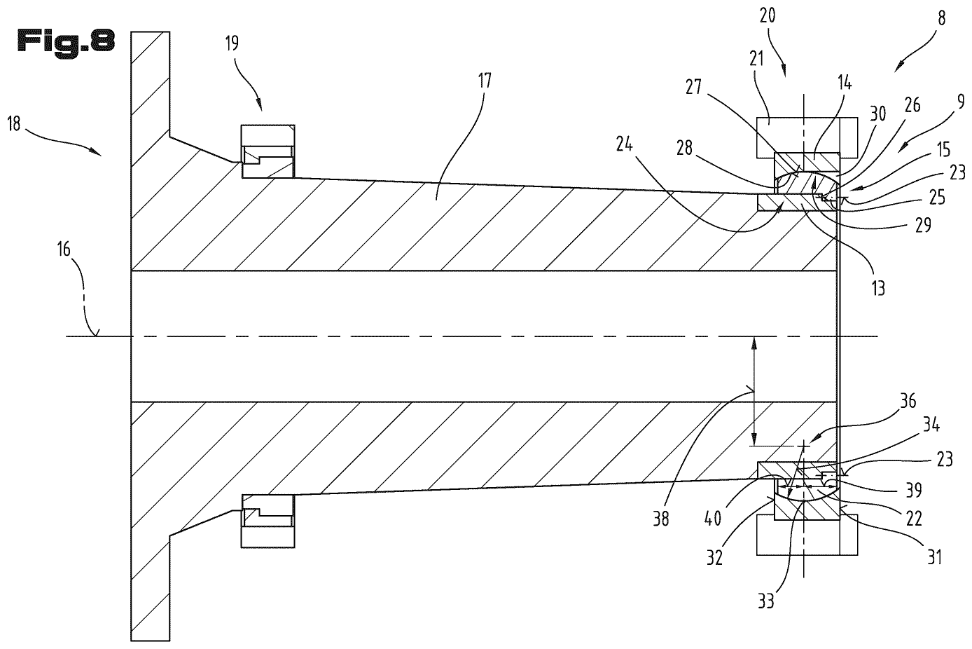

FIG. 8 a longitudinal section representation of a second example embodiment of a plain bearing arrangement;

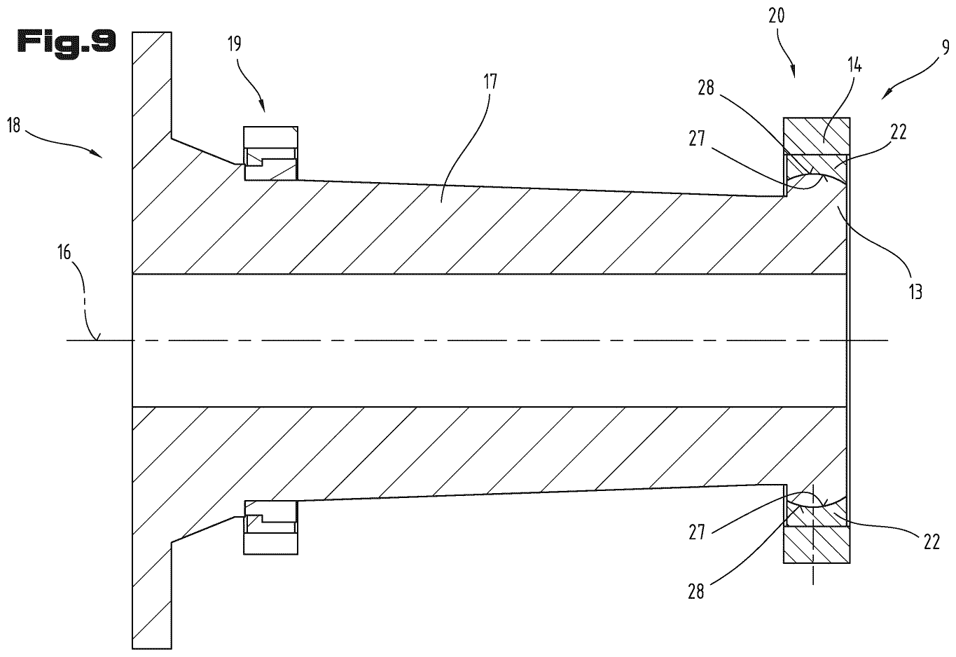

FIG. 9 a longitudinal section representation of a third example embodiment of a plain bearing arrangement.

It is worth noting here that the same parts have been given the same reference numerals or same component configurations in the embodiments described differently, yet the disclosures contained throughout the entire description can be applied analogously to the same parts with the same reference numerals or the same component configurations. The indications of position selected in the description, such as above, below, on the side etc. refer to the figure directly described and shown, and these indications of position can be applied in the same way to the new position should the position change.

FIG. 1 shows a schematic representation of a first example embodiment of a wind turbine 1 for generating electrical energy from wind energy. The wind turbine 1 comprises a nacelle 2, which is rotatably mounted on a tower 3. The nacelle 2 comprises a nacelle housing 4, which forms the main structure of the nacelle 2. The electrical components, such as a generator of the wind turbine 1, are arranged in the nacelle housing 4 of the nacelle 2.

Furthermore, a rotor 5 is provided, which has a rotor hub 6 with rotor blades 7 arranged thereon. The rotor hub 6 is considered to be part of the nacelle 2. The rotor hub 6 is mounted in a rotatable manner on the nacelle housing 4 by means of a rotor bearing arrangement 8. In particular, it is provided that a plain bearing arrangement 9 according to the invention and described in more detail is used as a rotor bearing arrangement 8.

The rotor bearing arrangement 8, which serves to mount the rotor hub 6 on the nacelle housing 4 of the nacelle 2, is configured to absorb a radial force 10 and an axial force 11. The axial force 11 results from the force of the wind. The radial force 10 results from the weight force of the rotor 5 and acts at the center of gravity of the rotor 5. Since the center of gravity of the rotor 5 is outside the rotor bearing arrangement 8, the radial force 10 causes a titling moment 12 in the rotor bearing arrangement 8. The tilting moment 12 can also be caused by an uneven load on the rotor blade 7. This tilting moment 12 can be absorbed by a second plain bearing arrangement, which is arranged at a distance to the plain bearing arrangement 9 according to the invention.

The rotor bearing arrangement 8 according to the invention can, for example, have a diameter between 0.5 m and 5 m. It is of course also conceivable that the rotor bearing arrangement 8 is smaller or larger.

FIG. 2 shows a first example embodiment of the nacelle 2 with the plain bearing arrangement 9. The plain bearing arrangement 9 is represented in longitudinal section in FIG. 2.

Of course, the plain bearing arrangement 9 represented in FIG. 2 can also be used in all other industrial applications besides wind turbines.

As can be seen from FIG. 2, it can be provided that the plain bearing arrangement 9 has an inner ring element 13 and an outer ring element 14. A plain bearing element 15 is arranged between the inner ring element 13 and the outer ring element 14, which serves for the rotatory plain bearing mounting of the inner ring element 13 relative to the outer ring element 14. The inner ring element 13 and the outer ring element 14 are thereby rotatable relative to one another about an axis of rotation 16.

In the example embodiment shown in FIG. 2, the inner ring element 13 is formed directly by a rotor shaft 17.

The rotor shaft 17 is represented schematically in FIG. 2. As can be seen from FIG. 2, it can be provided that the rotor shaft 17 has a rotor side 18. The rotor side 18 serves to receive the rotor hub 6, or the rotor hub 6 can be formed directly on the rotor side 18.

As can further be seen in FIG. 2, it can be provided that a first rotor shaft bearing 19 and a second rotor shaft bearing 20 are provided. The first rotor shaft bearing 19 can be arranged nearer to the rotor hub 6 or to the rotor side 18 than the second rotor shaft bearing 20. In particular, it can thereby be provided that the second rotor shaft bearing 20 is configured as a plain bearing arrangement 9 according to the following disclosures. The first rotor shaft bearing 19 can be configured as a floating bearing. The second rotor shaft bearing 20 can be configured as a fixed bearing.

Furthermore, it can be provided that the outer ring element 14 is coupled with the nacelle housing 4 by means of a bearing mount 21. In the example embodiment shown in FIG. 2, it is thus provided that the outer ring element 14 is rigidly coupled with the nacelle housing 4 and the inner ring element 13 is rotatable relative to the outer ring element 14 in relation to an axis of rotation 16 by means of the plain bearing element 15. Since in this example embodiment the rotor shaft 17, which can be coupled with the rotor hub 6 and thus with the rotor 5, directly forms the inner ring element 13, the rotor shaft 17 can thus be rotatably received by the plain bearing arrangement 9 in the nacelle housing 4.

FIG. 3 shows the plain bearing arrangement 9 of FIG. 2 in a perspective view. For the sake of clarity, in FIG. 3 the outer ring element 14 has been shifted in an exploded view in order to be able to show the details of the plain bearing arrangement 9. The bearing mount 21 has also been omitted. In the following, the plain bearing arrangement 9 is described referring jointly to FIGS. 2 and 3.

As can be seen from FIG. 3, the plain bearing element 15 comprises a plurality of separate plain bearing pads 22, which are distributed along the circumference between the inner ring element 13 and the outer ring element 14.

The individual plain bearing pads 22 can each be coupled with the inner ring element 13 by means of a fastening means 23.

In particular, it can be provided that the individual plain bearing pads 22 have a ledge 25 on their inner side 24. The ledge 25 can form a resting surface so that the plain bearing pad 22 can rest on an axial stop 26 of the inner ring element 13 in the region of the ledge 25. The plain bearing pad 22 can thus be positioned in the axial direction relative to the inner ring element 13.

In particular, it can be provided that the fastening means 23 is provided in the form of a fixing screw, by means of which the individual plain bearing pads 22 can be pressed against the axial stop 26 in the axial direction and thus fixed.

Due to the described structure, the individual plain bearing pads 22 can thus have a fixed connection with the inner ring element 13 in the operating mode of the plain bearing arrangement 9 and thus rotate with the inner ring element relative to the outer ring element 14. To enable the rotational movement between the inner ring element 13 and the outer ring element 14, a bearing surface 27 is configured on each of the individual plain bearing pads 22, which in the operable state of the plain bearing arrangement 9 rests at least partially on a counterface 28 of the outer ring element 14.

The counterface 28 is arranged on an inner side 29 of the outer ring element 14. The bearing surface 27 of the plain bearing pad 22 and the counterface 28 of the outer ring element 14 are configured as sliding surfaces that slide over one another during operation of the plain bearing arrangement 9. In particular, it can be provided that the counterface 28 of the outer ring element 14 is configured as a hard, wear-proof surface, which can be made from hardened steel, for example. The bearing surface 27 of the plain bearing pad 22 can be made from a, in comparison to the counterface 28, soft plain bearing material. It is of course also conceivable that the bearing surface 27 has a sliding coating.

As can be seen from FIGS. 2 and 3, it can be provided that a removal opening 30 is provided, which can serve for removing individual plain bearing pads 22. The removal opening 30 can, at least in sections, interrupt the counterface 28 formed in the outer ring element 14. In particular, it can be provided that the removal opening 30 extends starting from a first front side 31 of the outer ring element 14. In particular, it can be provided that the removal opening 30 does not extend up to a second front side 32 of the outer ring element 14. Rather, the removal opening 30 can extend only up to an axial vertex 33.

To exchange the individual plain bearing pads 22, it is not necessary for the load of the shaft to be absorbed by an external bearing arrangement, rather it can be provided that only a single plain bearing pad 22 is exchanged for a new plain bearing pad 22 at any one time, with this process being repeated until all plain bearing pads 22 have been exchanged. The fastening means 23 can thereby be released and after removing the fastening means 23 the free plain bearing pad 22 can be removed in an axial direction from the inner ring element 13.

A new plain bearing pad 22 can then be inserted into the position of the old plain bearing pad 22 according to the above description. The newly inserted plain bearing pad 22 can subsequently be fixed and the inner ring element 13 rotated so that the next plain bearing pad can be exchanged according to the steps described above. This process can be repeated until all plain bearing pads 22 have been exchanged.

FIG. 4 shows a perspective view of the plain bearing pad 22, where the same reference numerals or component designations are used for the same parts as in the preceding FIGS. 1 to 3. To avoid unnecessary repetition, reference is made to the detailed description in the preceding FIGS. 1 to 3.

FIG. 5 shows a cross-section representation of the plain bearing arrangement 9, where the same reference numerals or component designations are used for the same parts as in the preceding FIGS. 1 to 4. To avoid unnecessary repetition, reference is made to the detailed description in the preceding FIGS. 1 to 4.

In FIG. 6, a segment of the bearing surface 27 is plotted on a constructively represented torus, wherein the first radius 34 and the second radius 35 are plotted.

For the cross-section representation of FIG. 5, a cutting plane line according to V-V in FIG. 2 was selected, wherein the cutting plane line runs exactly through the axial vertex 33.

The embodiment of the plain bearing pad 22 according to the invention is described referring jointly to FIGS. 2 to 5.

As can be seen from FIGS. 2 to 6, it can be provided that the bearing surface 27 has a first radius 34 and a second radius 35. The second radius 35 extends from the axis of rotation 16 to the axial vertex 33. In particular, it can be provided that the second radius 35 runs in the circumferential direction of the bearing surface 27.

The first radius 34 runs in the axial direction. As can be seen from the figures, it can be provided that the first radius 34 has a center point 36. The first center point 36 can be in the plane of the axial vertex 33 and be spaced at a center point distance 38 from the axis of rotation 16.

The second radius 35 can have a second center point 37. The second center point 37 can be on the axis of rotation 16. In particular, it can be provided that through the formation of the first radius 34 and the second radius 35, the bearing surface 27 forms a segment of an enveloping surface of a torus with a circular cross-sectional surface.

As can further be seen from FIGS. 2 to 6, it can be provided that the plain bearing pad 22 extends in the axial direction starting from the axial vertex 33 in a first axial extension 39 and starting from the axial vertex 33 in a second axial extension 40. In sum, the first axial extension 39 and the second axial extension 40 amount to a plain bearing pad width 41.

As can be seen particularly well from FIG. 2, it can be provided that the first axial extension 39 is greater than the second axial extension 40. This measure means that the plain bearing pad 22 is pulled further inwards on the first front side 31 of the outer ring element 14 than on the second front side 32 of the outer ring element 14. The plain bearing arrangement 9 can thus absorb a greater axial force in a first axial direction than in a second axial direction. The reasons for that and the advantages of the embodiment according to the invention are explained in conjunction with FIG. 7.

FIG. 7 shows a close-up representation of the plain bearing arrangement 9, as is shown in FIG. 2, where the same reference numerals or component designations are used for the same parts as in the preceding FIGS. 1 to 6. To avoid unnecessary repetition, reference is made to the detailed description in the preceding FIGS. 1 to 6.

As can be seen from FIG. 7, a first axial overlap 42 results from the selection of the first radius 34 and the first axial extension 39. The first axial overlap 42 determines the projected axial bearing surface, whereby the axial load capacity of the plain bearing arrangement 9 can be ascertained.

Similarly, a second axial overlap 43 is determined by the first radius 34 and the second axial extension 40. The second axial overlap 43 determines a projected axial bearing surface and thus determines the possible load capacity of the plain bearing arrangement 9 in a second axial direction.

A possible load capacity of the plain bearing arrangement 9 in the radial direction is determined by the plain bearing pad width 41.

A comparable spherical cap surface 44 is plotted schematically in FIG. 7 to illustrate the advantages over a plain bearing pad with a spherical cap surface. The spherical cap surface 44 would hereby have a spherical cap radius 45 that would be equal to the second radius 35. As can be seen particularly clearly from FIG. 7, a third axial overlap 46 of the spherical cap surface 44 would thus be significantly smaller than the first axial overlap 42. A plain bearing with a spherical cap surface 44 configured in such a way with the same plain bearing width 41 could thus only absorb a lower axial load.

Unlike the example embodiment of FIGS. 2 to 7, in an example embodiment not shown here it can be provided that the second radius 35 is smaller than the first radius 34. In such an example embodiment, the bearing surface 27 has a basic shape similar to an American football.

In FIG. 8, a further and possibly independent embodiment of the plain bearing arrangement 9 is shown, again using the same reference numerals or component designations for the same parts as in the preceding FIGS. 1 to 7. To avoid unnecessary repetition, reference is made to the detailed description in the preceding FIGS. 1 to 7.

As can be seen from FIG. 8, it can be provided that the inner ring element 13 is provided as a structurally independent element that is received on the rotor shaft 17.

In FIG. 9, a further and possibly independent embodiment of the plain bearing arrangement 9 is shown, again using the same reference numerals or component designations for the same parts as in the preceding FIGS. 1 to 8. To avoid unnecessary repetition, reference is made to the detailed description in the preceding FIGS. 1 to 8.

As can be seen from FIG. 9, it can be provided that the plain bearing pads 22 are mounted on the outer ring element 14. The counterface 28 can thus be formed on the inner ring element 13. In the example embodiment as is shown in FIG. 9, it can be provided that the inner ring element 13 is formed as part of the rotor shaft 17.

In an alternative embodiment variation not shown here based on the embodiment according to FIG. 9, it can also be provided that the inner ring element 13, on which the counterface 28 is formed, is provided in the form of an individually formed component that is received on the rotor shaft 17.

The example embodiments show possible embodiment variations, although it is to be noted here that the invention is not limited to the specifically represented embodiment variations of the same, but rather various combinations of the individual embodiment variations with one another are possible, and that given the technical teachings provided by the present invention this variation possibility is within the ability of the skilled person in this technical field.

The scope of protection is defined by the claims. The description and the drawings should, however, be consulted when construing the claims. Individual features or combinations of features from the various example embodiments as shown and described can constitute separate inventive solutions. The problem to be solved by the individual inventive solutions can be derived from the description.

All value ranges specified in the current description are to be understood such that they include any and all sub-ranges, e.g., the specification 1 to 10 is to be understood such that all sub-ranges, starting from the lower limit 1 and the upper limit 10 are included, i.e., all sub-ranges begin with a lower limit of 1 or more and end at an upper limit of 10 or less, e.g., 1 to 1.7, or 3.2 to 8.1, or 5.5 to 10.

As a matter of form and by way of conclusion, it is noted that, to improve understanding of the structure, elements have partially not been shown to scale and/or enlarged and/or shrunk.

List of reference numerals

| | |
|---|---|
| 1 | Wind turbine |
| 2 | Nacelle |
| 3 | Tower |
| 4 | Nacelle housing |
| 5 | Rotor |
| 6 | Rotor hub |
| 7 | Rotor blade |
| 8 | Rotor bearing arrangement |
| 9 | Plain bearing arrangement |
| 10 | Radial force |
| 11 | Axial force |
| 12 | Tilting moment |
| 13 | Inner ring element |
| 14 | Outer ring element |
| 15 | Plain bearing element |
| 16 | Axis of rotation |
| 17 | Rotor shaft |
| 18 | Rotor side |
| 19 | First rotor shaft bearing |
| 20 | Second rotor shaft bearing |
| 21 | Bearing mount |
| 22 | Plain bearing pad |
| 23 | Fastening means |
| 24 | Inner side |
| 25 | Ledge |
| 26 | Axial stop |
| 27 | Bearing surface |
| 28 | Counterface |
| 29 | Inner side |
| 30 | Removal opening |
| 31 | First front side outer ring element |
| 32 | Second front side outer ring element |
| 33 | Axial vertex |
| 34 | First radius |
| 35 | Second radius |
| 36 | First center point |
| 37 | Second center point |
| 38 | Center point distance |
| 39 | First axial extension |
| 40 | Second axial extension |
| 41 | Plain bearing pad width |
| 42 | First axial overlap |
| 43 | Second axial overlap |
| 44 | Spherical cap surface |
| 45 | Spherical cap radius |
| 46 | Third axial overlap |

1. A plain bearing arrangement (9) comprising:
an inner ring element (13);
an outer ring element (14);
at least one plain bearing element (15) arranged between the inner ring element (13) and the outer ring element (14), wherein by means of the plain bearing element (15) the outer ring element (14) and the inner ring element (13) are mounted such that they can be rotated relative to one another about an axis of rotation (16), wherein the plain bearing element (15) comprises a plurality of plain bearing pads (22), wherein the individual plain bearing pads (22) each have a curved bearing surface (27),
wherein
the curved bearing surface (27) has a first radius (34) in a longitudinal section along the axis of rotation (16) and has a second radius (35) in a cross section normal to the axis of rotation (16), in particular wherein the second radius (35) is larger than the first radius (34).

2. The plain bearing arrangement (9) according to claim 1, wherein the bearing surface (27) of the plain bearing pads (22) is configured as a torus segment of a torus with a circular cross section.

3. The plain bearing arrangement (9) according to claim 1, wherein the first radius (34) is between 5% and 99%, in particular between 10% and 50%, preferably between 15% and 30% of the second radius (35).

4. The plain bearing arrangement (9) according to claim 1, wherein the second radius (35) is measured at an axial vertex (33).

5. The plain bearing arrangement (9) according to claim 4, wherein the plain bearing pads (22), starting from the axial vertex (33), have a first axial extension (39) in a first axial direction and a second axial extension (40) in a second axial direction, wherein the first axial extension (39) is greater than the second axial extension (40).

6. The plain bearing arrangement (9) according to claim 5, wherein the second axial extension (40) is between 5% and 99%, in particular between 20% and 95%, preferably between 50% and 80% of the first axial extension (39).

7. The plain bearing arrangement (9) according to claim 4, wherein the plain bearing pads (22), starting from the axial vertex (33), have a first axial extension (39) in a first axial direction and a second axial extension (40) in a second axial direction, wherein the first axial extension (39) is equal to the second axial extension (40).

8. The plain bearing arrangement (9) according to claim 1, wherein the plain bearing pads (22) have a plain bearing pad width (41), wherein the plain bearing pad width (41) is between 20% and 170%, in particular between 60% and 140%, preferably between 90% and 120% of the first radius (34).

9. The plain bearing arrangement (9) according to claim 1, wherein the second radius (35) has a different value to the first radius (34), wherein the first radius (34) has a constant value over the entire axial extension of the bearing surface.

10. The plain bearing arrangement (9) according to claim 1, wherein the second radius (35) is smaller than the first radius (34).

11. A nacelle (2) for a wind turbine (1), the nacelle (2) comprising:
a nacelle housing (4);
a rotor hub (6);
a rotor bearing arrangement (8) for mounting the rotor hub (6) on the nacelle housing (4), wherein the rotor bearing arrangement (8) comprises a plain bearing arrangement (9) according to claim 1, which has plain bearing pads (22).

12. The nacelle (2) according to claim 11, wherein the plain bearing pads (22) of the plain bearing arrangement (9), starting from the axial vertex (33), have a first axial extension (39) in a first axial direction and a second axial extension (40) in a second axial direction, wherein the first axial extension (39) is greater than the second axial extension (40), wherein the plain bearing pads (22) are received in the nacelle housing (4) in such a way that the first axial extension (39) is formed on a side of the axial vertex (33) that is facing away from the rotor hub (6).

13. The nacelle (2) according to claim 11, further comprising a first rotor shaft bearing (19) and a second rotor shaft bearing (20), wherein the first rotor shaft bearing (19) is arranged nearer to the rotor hub (6) than the second rotor shaft bearing (20), wherein the second rotor shaft bearing (20) is configured as a plain bearing arrangement (9) comprising:
an inner ring element (13);
an outer ring element (14);
at least one plain bearing element (15) arranged between the inner ring element (13) and the outer ring element (14),
wherein by means of the plain bearing element (15) the outer ring element (14) and the inner ring element (13) are mounted such that they can be rotated relative to one another about an axis of rotation (16),
wherein the plain bearing element (15) comprises a plurality of plain bearing pads (22),
wherein the individual plain bearing pads (22) each have a curved bearing surface (27), and
wherein the curved bearing surface (27) has a first radius (34) in a longitudinal section along the axis of rotation (16) and has a second radius (35) in a cross section normal to the axis of rotation (16).

14. The nacelle (2) according to claim 11, wherein the plain bearing pads (22) are mounted on a rotor shaft (17).

15. The nacelle (2) according to claim 11, wherein the plain bearing pads (22) are mounted on the nacelle housing (4).

16. A wind turbine (1) with a nacelle (2), the nacelle (2) comprising:
a nacelle housing (4);
a rotor hub (6) with rotor blades arranged thereon;
a rotor bearing arrangement (8) for mounting the rotor hub (6) on the nacelle housing (4), wherein the rotor bearing arrangement (8) comprises the plain bearing arrangement (9) according to claim 1.
